(19) United States
(12) Patent Application Publication
(10) Pub. No.: US 2005/0216453 A1
(43) Pub. Date: Sep. 29, 2005

(54) System and method for data classification usable for data search

(76) Inventors: Koichi Sasaki, Kawasaki-shi (JP); Yoshifumi Takayama, Fuchu-shi (JP); Hideki Hirakawa, Yokohama-shi (JP)

Correspondence Address: FINNEGAN, HENDERSON, FARABOW, GARRETT & DUNNER;LLP, 901 NEW YORK AVENUE, NW, WASHINGTON, DC, 20001-4413, US

(21) Appl. No.: 11/080,814

(22) Filed: Mar. 16, 2005

(30) Foreign Application Priority Data
Mar. 23, 2004 (JP) 2004-084710

(51) Int. Cl. G06F 17/30

(52) U.S. Cl. 707/3

(57) ABSTRACT

A user interface enables the user to select a classification scheme from a group of classification schemes indicated by classification scheme information. The classification scheme information is stored in a classification-scheme storage unit as results of classification performed on data of arbitrary databases. The user interface also enables the user to select, from the group of databases, a database to which the selected classification scheme is applied. A classification module classifies the data of the selected database based on the selected classification scheme.

### CROSS-REFERENCE TO RELATED APPLICATIONS

This application is based upon and claims the benefit of priority from prior Japanese Patent Application No. 2004-084710, filed Mar. 23, 2004, the entire contents of which are incorporated herein by reference.

### BACKGROUND OF THE INVENTION

1. Field of the Invention

The present invention relates to a data search system capable of using, for data search, a classification scheme for data classification of a database, and more particularly to a data search system suitable for data classification utilizing an existing classification scheme, and a method employed in the system.

2. Description of the Related Art

Various data search systems for searching a database for data corresponding to search conditions designated by a user have been so far developed. Jpn. Pat. Appln. KOKAI Publication No. 7-44568 (hereinafter referred to as “document 1”) discloses a data search system capable of gradually narrowing a search by classifying the data of a database into a plurality of groups. Specifically, document 1 describes use of various classification methods for the database, using parameters or file attributes, in order to classify the data of the database into a plurality of groups. In this data search system, users can select a desired classification method from a classification method list. To narrow a search, it is sufficient if the users repeat the operation of selecting a classification method, and the operation of selecting a to-be classified target method based on the classification results acquired by the first-selected classification method.

Japanese Patent No. 3238023 (hereinafter referred to as “document 2”) discloses a technique for hierarchically expressing a classification scheme acquired by classifying the data of a database. It is possible to employ the classification scheme expression method, disclosed in document 2, in the data search system disclosed in document 1, thereby providing users with classification results expressed hierarchically. In this case, the users can easily recognize the classification scheme indicated by the classification results. However, to make the data search system of document 1 perform the above-described classification on a new database, the users must repeat the selection of a classification method, and the selection of a to-be classified target based on the classification results acquired by the first-selected classification method, which is very troublesome.

Further, in the data search system disclosed in document 1, a list of search conditions is displayed based on the history of the search conditions. As a result, the users can select a desired search condition from the list. However, they cannot grasp the situation assumed when any one of the search conditions is selected from the list. Accordingly, in this system, it is difficult for the users to efficiently re-utilize search conditions utilized in the past.

### BRIEF SUMMARY OF THE INVENTION

In accordance with an embodiment of the invention, there is provided a data search system. The data search system comprises a search module, user interface and classification module. The search module is configured to search, for data, an arbitrary database selected from a group of databases, using a search condition designated by a user. The search module can utilize, for a search of the data, a classification scheme of data of the selected database. The user interface is configured to enable the user to select an arbitrary classification scheme from a group of classification schemes indicated by classification scheme information, and also to enable the user to select, from the group of databases, a database to which the selected classification scheme is applied. The classification scheme information is stored in a classification-scheme storage unit as results of classification performed on data of arbitrary databases. The classification module is configured to classify the data of the selected database based on the selected classification scheme.

In accordance with another embodiment of the invention, the classification scheme information stored in the classification-scheme storage unit has a hierarchical structure including a group of classification folders. Further, the user interface includes a data-providing module configured to display, on a display unit, an arbitrary classification scheme included in the group of classification schemes and selected in accordance with a user operation. The search module is used to search data belonging to a classification folder in a classification scheme included in the group of classification schemes and displayed by the data-providing module, and to store, linked to the classification folder into one of a search-condition storage unit and the classification-scheme storage unit, a search-condition-log folder including a log of a search condition used for the search, when the user selects the classification folder and instructs the search module to search the data. The search-condition storage unit is used to store a search condition designated by the user. The data-providing module displays a search-condition-log folder as part of the selected classification scheme, when the search-condition-log folder exists, linked to a classification folder in a classification scheme included in the group of classification schemes and selected in accordance with a user operation.

### BRIEF DESCRIPTION OF THE SEVERAL VIEWS OF THE DRAWING

The accompanying drawings, which are incorporated in and constitute a part of the specification, illustrate embodiments of the invention, and together with the general description given above and the detailed description of the embodiments given below, serve to explain the principles of the invention.

FIG. 1 is a block diagram illustrating the configuration of a data search system according to an embodiment of the invention;

FIG. 2 is a view illustrating a display area arrangement example on the display screen of the display unit 15 appearing in FIG. 1;

FIG. 3 is a view illustrating a classification icon and a classification scheme example designated by the icon;

FIG. 4 is a flowchart illustrating the procedure of a process including an automatic classification process in the embodiment;

FIG. 5 is a flowchart illustrating, in more detail, the procedure of the automatic classification process;

FIG. 6 is a view illustrating the flow of data during a data search in the embodiment;

FIG. 7 is a view illustrating a display screen example of a classification scheme including a search-condition-log folder;

FIG. 8 is a flowchart illustrating the procedure of a search process utilizing a search condition log and performed in the embodiment;

FIG. 9 is a view illustrating the flow of data during search in a modification of the embodiment;

FIG. 10 is a view illustrating a display screen example, used during search, utilizing a search-condition-log-icon list; and

FIG. 11 is a flowchart illustrating the procedure of a search process utilizing the search-condition-log-icon list.

### DETAILED DESCRIPTION OF THE INVENTION

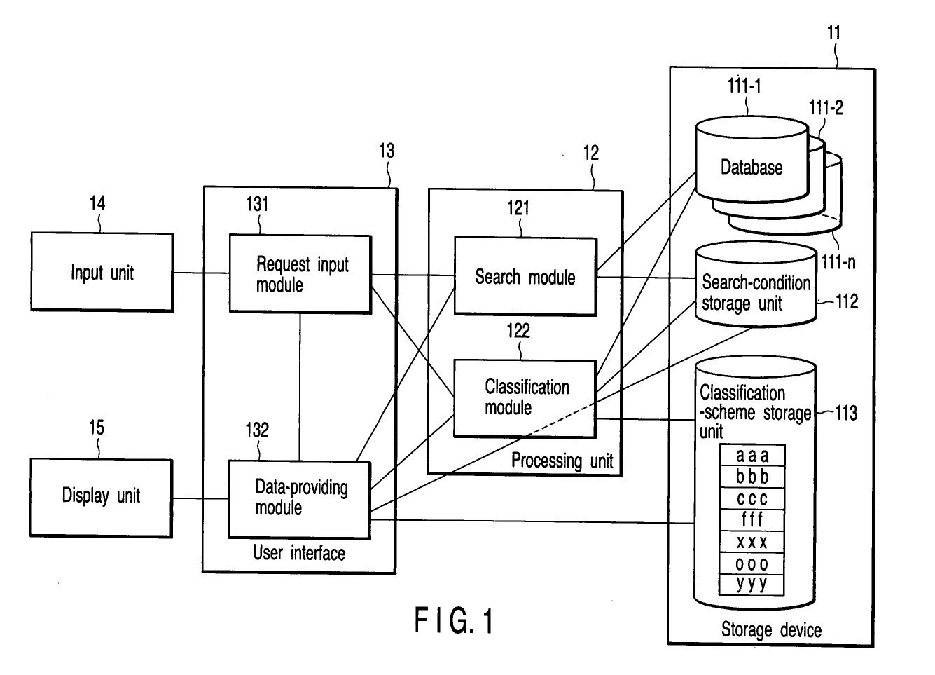

An embodiment of the invention will be described in detail with reference to the accompanying drawings. FIG. 1 is a block diagram illustrating the configuration of a data search system according to the embodiment of the invention. As shown, the data search system comprises a storage device 11, processing unit 12, user interface 13, input unit 14 including a keyboard and mouse, and display unit 15. The storage device 11 includes databases 111-1 (DB1) to 111-n (DBn), search-condition storage unit (search criteria storage unit) 112 and classification-scheme storage unit 113.

The databases 111-1 to 111-n store data, such as document data, to be searched for. The search-condition storage unit 112 stores search conditions designated by a user via the user interface 13. The classification-scheme storage unit 113 stores classification scheme information. The classification scheme information indicates a classification scheme acquired by classifying data (document data) stored in at least one database 111-i (i=1, . . . , n). The classification scheme includes, for example, hierarchical classes. The classification scheme information has a hierarchical structure. The hierarchical structure includes a group of classification folders that reflect the classification scheme indicated by the classification information.

The processing unit 12 includes a search module (retrieval module) 121 and classification module 122. The search module 121 searches for data stored in the database 111-i, using a search condition designated by a user through the user interface 13. The classification module 122 classifies data stored in the database 111-i and acquires a classification scheme.

The user interface 13 is used as an input/output interface between the group of the input unit 14 and display unit 15 and the group the processing unit 12 and storage device 11. The user interface 13 includes a request input module 131 as an input interface, and a data-providing module 132 as an output interface. The request input module 131 transfers, to the search module 121 or classification module 122, various requests input by a user through the input unit 14. The data-providing module 132 displays, on the display screen of the display unit 15, the search results of the search module 121, the classification results of the classification module 122, a database list, a classification scheme list, and a classification scheme, when requested. The database list is a list of databases 111-1 to 111-n. The classification scheme list is a list of classification schemes indicated by the classification information stored in the classification-scheme storage unit 113. The list of classification schemes employed in the embodiment is a list of iconized classification schemes, i.e., a list of classification icons.

In the embodiment, assume that the data search system shown in FIG. 1 is realized by a personal computer. In this case, the search module 121, classification module 122, request input module 131 and data-providing module 132 are realized by reading and executing, using the computer, a program (clustering program) that describe respective procedures corresponding to the modules. The program can be prestored in a computer-readable medium and distributed. The programs may be downloaded (distributed) via a network.

In the embodiment, an external storage device for the computer, e.g., a hard disk drive (HDD), is used as the storage device 11. Accordingly, the databases 111-1 to 111-n, search-condition storage unit 112 and classification-scheme storage unit 113 are incorporated in a disk drive. However, some or all of them may be independent of the data search system. For instance, they may be incorporated in a database server computer connected to the data search system (i.e., the personal computer) via a network.

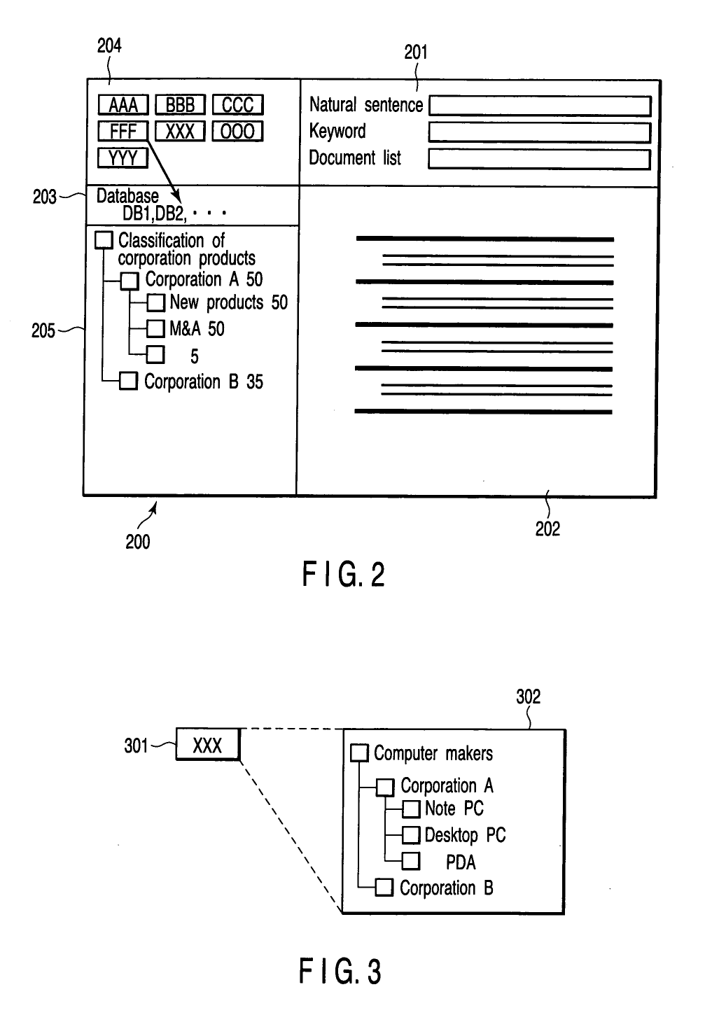

FIG. 2 is a view illustrating a display area arrangement example on the display screen 200 of the display unit 15. In the example of FIG. 2, on the display screen 200, there are provided a search input area 201, search-result/classification-result display area 202, database-list display area 203, classification-icon-list display area 204 and classification-scheme display area 205. The search input area 201 provides an area to which a user inputs a search condition. The search-result/classification-result display area 202 is used to display the search results of the search module 121 or the classification results of the classification module 122. The database-list display area 203 is used to display the list of databases 111-1 (DB1) to 111-n (DBn). The classification-icon-list display area 204 is used to display the list of classification icons (classification scheme icons). The classification-scheme display area 205 is used to display the classification scheme specified by a classification icon selected from the classification-icon-list display area 204. Assume here that the data of an arbitrary database indicated in the database-list display area 203 is classified in accordance with the classification scheme displayed on the classification-scheme display area 205. In this case, the classification results are reflected on the classification scheme displayed in the classification-scheme display area 205. FIG. 3 shows a classification icon 301 and an example of a classification scheme 302 designated by the icon 301.

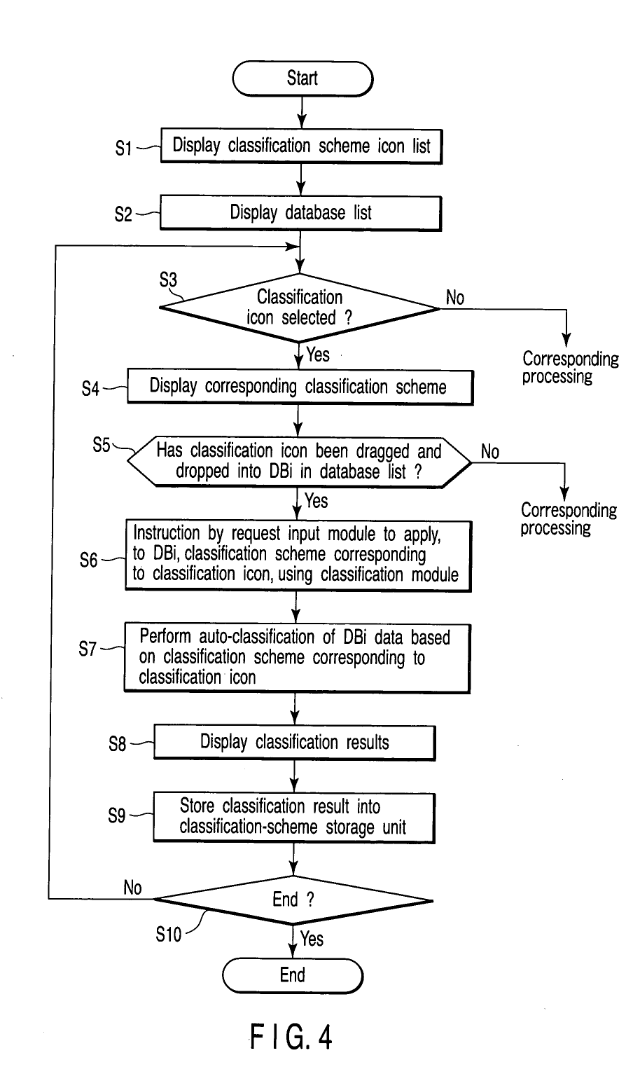

Referring to the flowchart of FIG. 4, a description will be given of the operation of the data search system of FIG. 1, using, as an example, the case of classifying the data of a database, designated by a user, in accordance with a classification scheme designated by the user. The classification-scheme storage unit 113 stores classification scheme information indicating each of the classification schemes expressed in a hierarchical structure (a tree structure). The classification schemes are acquired by classifying the data of some databases included in the databases 111-1 (DB1) to 111-n (DBn). In other words, the classification-scheme storage unit 113 stores a group of classification scheme information items linked to databases corresponding thereto. Specifically, assume that the classification-scheme storage unit 113 stores classification scheme information items “aaa”, “bbb”, “ccc”, “fff”, “xxx”, “ooo” and “yyy”. The classification scheme information in the classification-scheme storage unit 113 may be automatically generated by the classification module 122 of the data search system or an external system, in accordance with a command from the user, or manually generated.

The data-providing module 132 generates a list of classification icons (classification scheme icons) indicating classification schemes that indicate the classification scheme information items “aaa”, “bbb”, “ccc”, “fff”, “xxx”, “ooo” and “yyy” stored in the classification-scheme storage unit 113, in accordance with IDs (classification scheme IDs) for specifying the classification scheme information items. The data-providing module 132 displays the generated classification icon list on the classification-icon-list display area 204 of the display screen 200 of the display unit 15 (step S1). The data-providing module 132 also displays the list of databases 111-1 to 111-n (database list) in the data search system, on the database-list display area 203 of the display screen 200 of the display unit 15 (step S2). In the example of FIG. 2, the classification-icon-list display area 204 displays a list of classification icons “AAA”, “BBB”, “CCC”, “FFF”, “XXX”, “OOO” and “YYY” corresponding to the IDs of the classification scheme information items “aaa”, “bbb”, “ccc”, “fff”, “xxx”, “ooo” and “yyy”, respectively.

Assume here that the classification icon list and database list are displayed on the classification-icon-list display area 204 and database-list display area 203, respectively. In this state, the user of the data search system of FIG. 1 performs an operation for selecting a desired classification icon from the classification-icon-list display area 204, using a mouse included in the input unit 14. Assume here that classification icon “FFF” has been selected. The request input module 131 informs the data-providing module 132 that the classification icon “FFF” has been selected.

Upon detecting, from the information from the request input module 131, that the classification icon “FFF” has been selected (step S3), the data-providing module 132 proceeds to step S4. At step S4, the data-providing module 132 reads, from the classification-scheme storage unit 113, the classification scheme information “fff” specified by the selected classification icon “FFF”. At step S4, the data-providing module 132 also displays the classification scheme indicated by the classification scheme information “fff” on the classification-scheme display area 205 of the display screen 200. As a result, the user can recognize, on the classification-scheme display area 205, the classification scheme corresponding to the classification scheme information “fff” they selected.

Further, assume that the user would like to classify, using the classification module 122, the data of the database 111-i (DBi) in accordance with the classification scheme corresponding to the classification icon “FFF” selected from the classification-icon-list display area 204. In this case, the user performs an operation for drag & drop (D & D) of the classification icon “FFF” to DBi of the database list on the database-list display area 203 of the display screen 200.

Upon detecting drag & drop (D & D) of the classification icon “FFF” to DBi of the database list (step S5), the request input module 131 instructs the classification module 122 to apply, to the database 111-i (DBi), the classification scheme corresponding to the classification icon “FFF” (step S6). The classification module 122, in turn, automatically executes classification processing for classifying the data (document data) of the database 111-i (DBi) based on the classification scheme (existing classification scheme) corresponding to the classification icon “FFF” (step S7).

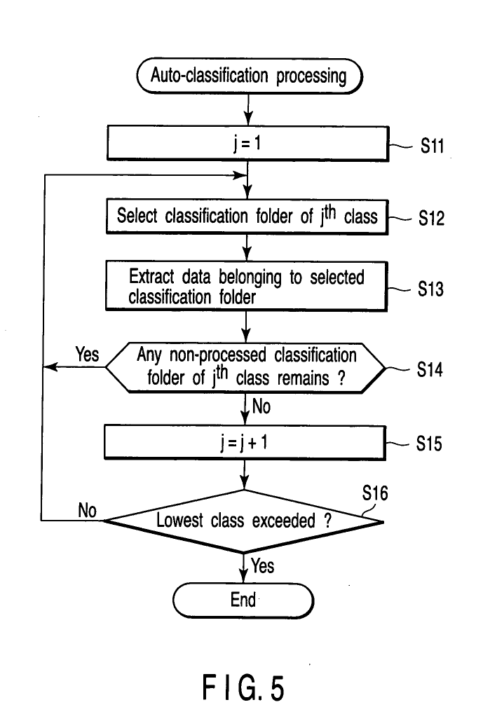

Referring now to the flowchart of FIG. 5, the details of the classification process (automatic classification process) performed at step S7 will be described. Firstly, the classification module 122 sets a variable j, used for designating a class in the classification scheme, to an initial value of 1 indicating the first class (the uppermost class) (step S11). Subsequently, the classification module 122 selects a classification folder (classification item) of the j^{th} class (step S12). After that, the classification module 122 extracts, from the database 111-i (DBi), data (document data) belonging to the selected j^{th}-class classification folder (step S13), and repeats steps S12 and S13 for all j^{th}-class classification folders (step S14). After extracting data (document data) belonging to all j^{th}-class classification folders, the classification module 122 increments the variable j by 1 (step S15).

The classification module 22 determines whether the class (j^{th} class) designated by the incremented variable j exceeds the lowest class of the classification scheme (step S16). If the j^{th} class does not exceed the lowest class, the classification module 122 returns to step S12. At step S12, the classification module 122 selects a classification folder of the j^{th} class. At the next step S13, the classification module 122 extracts data (document data) belonging to this j^{th}-class classification folder. When a parent classification folder (i.e., a higher-class classification folder) exists with respect to the j^{th}-class classification folder as in the above case, it is advisable to extract data (document data) belonging to the j^{th}-class classification folder, not from the entire database 111-i (DBi), but from data, previously extracted, belonging to the parent classification folder.

After finishing the extraction of data belonging to all classification folders of all classes (step S16), the classification module 122 finishes the automatic classification process at step S7. At this time, the data-providing module 132 displays the automatic classification results of the classification module 122 on the classification-scheme display area 205 of the display screen 200 (step S8). At this step, the data-providing module 132 reflects the automatic classification results of the classification module 122 in the classification scheme displayed on the classification-scheme display area 205. For instance, the data-providing module 132 displays the number of data items (documents) belonging to each of the classification folders (classification items, nodes) displayed on the classification-scheme display area 205.

On the other hand, after finishing the automatic classification process (step S7), the classification module 122 stores, into the classification-scheme storage unit 113, the classification results corresponding to the data of the database 111-i (DBi) (step S9). Specifically, the classification module 122 stores, into the classification-scheme storage unit 113, the classification results corresponding to the data of the database 111-i (DBi), with the classification results linked to the database 111-i and the classification scheme information in the classification-scheme storage unit 113 specified by the classification icon selected by the user.

As described above, the embodiment can visually provide users with a list of existing classification schemes, by displaying a list of classification icons. As a result, the users can easily select a desired classification scheme from the classification icon list (i.e., the users can easily select a desired classification scheme from a group of classification schemes indicated by the classification icon list). Further, in the embodiment, a database list is displayed, which enables the users to easily select a database to which the existing classification scheme specified by their selected classification icon is applied. In the embodiment, the data of the database selected by the user is classified based on the classification scheme selected by the user. Thus, in the embodiment, only if a user selects an existing classification scheme and database, the data of the selected database can be easily and automatically classified by utilizing the selected classification scheme. Moreover, this automatic classification can be performed simply by a user's selecting, from a classification icon list, a classification icon indicating a desired classification scheme, and dragging and dropping the selected classification icon to a desired database included in a database list. Thus, existing classification schemes can be extremely easily utilized for data classification of an arbitrary database.

When there are a plurality of databases to which a user would like to apply a classification scheme, it is sufficient if they perform the drag & drop operation on each of the databases included in a database list. Alternatively, a display area that displays a plurality of selected databases may be prepared on the display screen 200, and the drag & drop operation may be performed on the display area. Also in this case, a selected classification scheme can be applied to all selected databases.

Furthermore, classification scheme information can be stored in a file format in the classification-scheme storage unit 113. Namely, information indicating classification schemes can be stored as classification scheme files in the classification-scheme storage unit 113. In this case, the data-providing module 132 may display, instead of a classification icon list, a classification scheme file list on a classification-scheme-file-list display area (that corresponds to the classification-icon-list display area 204), thereby permitting users to select an arbitrary classification scheme file from the classification scheme file list. This enables a classification scheme indicated by the classification scheme file selected from the classification scheme file list to be applied to the database selected from the database list. Furthermore, a desired classification scheme file may be selected by causing a user to input its file name.

Assume here that a user selected classification scheme is displayed on the classification-scheme display area 205, and that an arbitrary database is selected, by a user operation, from a database list displayed on the database-list display area 203. Assume further that the data of the selected database is already classified by the classification scheme displayed on the classification-scheme display area 205, and the classification results are stored in the classification-scheme storage unit 113. In this case, the number of data items (documents), which belong to each classification folder (classification item) of the selected classification scheme displayed on the area 205, is displayed in the vicinity of each folder.

In the embodiment, when a classification scheme is displayed on the classification-scheme display area 205, users can select, from the classification scheme, an arbitrary classification folder (classification item) forming a node of the classification structure, by operating the input unit 14. Assume here that a user has selected an arbitrary classification folder from the classification scheme. At this time, the data-providing module 132 displays, as classification results on the search-result/classification-result display area 202, data items (documents) belonging to the selected classification folder, which are included in the results of classification performed by applying the classification scheme to the database currently selected from the database list displayed on the database-list display area 203. The data items belonging to the selected classification folder are displayed in the order beginning with, for example, the data item most suitable to the classification folder. Further, in the embodiment, data (document), related to a natural sentence or a keyword, designated by a user, can be searched for directly from the classification folder (classification item) selected by the user.

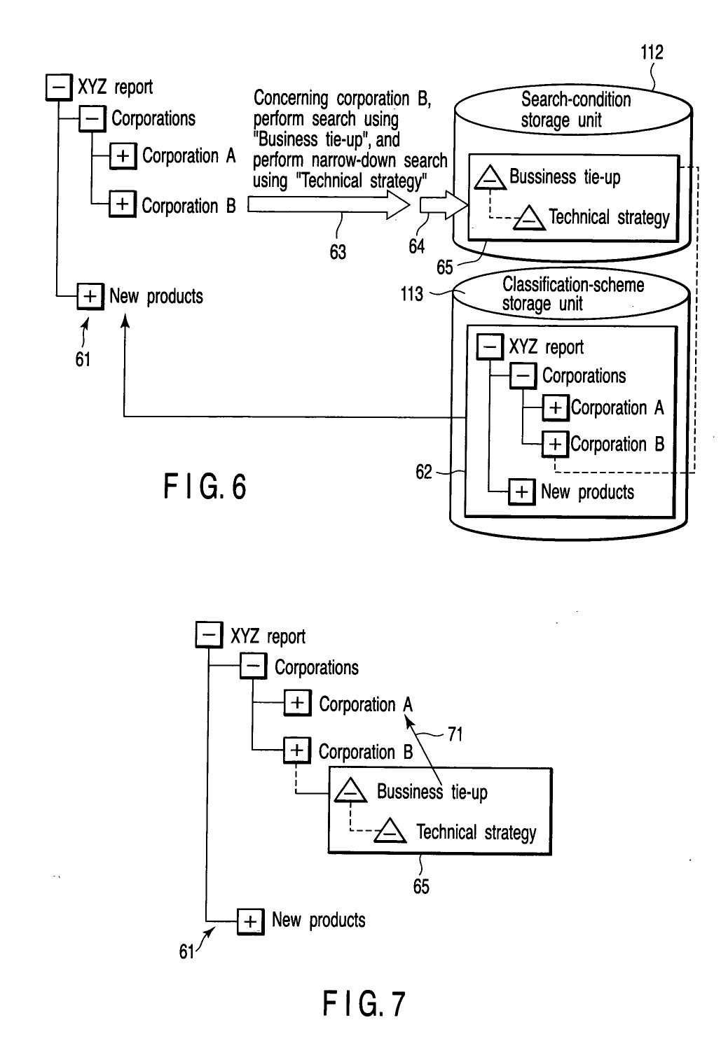

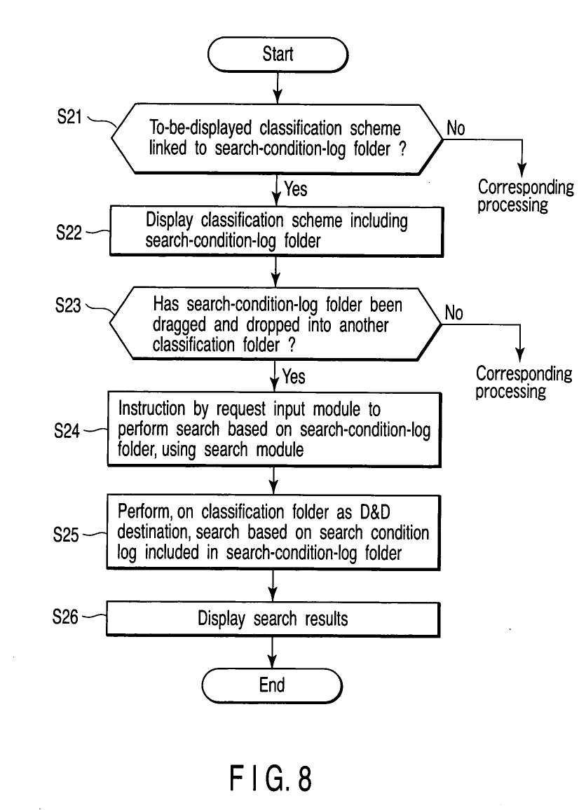

Referring to FIGS. 6 to 8, a description will be given of a data search, using a narrow-down search as an example. FIG. 6 is a view illustrating the flow of data during a data search. FIG. 7 is a view illustrating a display screen example of a classification scheme including a search condition log folder. FIG. 8 is a flowchart illustrating the procedure of a search process utilizing a search condition log. Firstly, assume that the classification scheme 61 shown in FIG. 6 is displayed on the classification-scheme display area 205 of the display screen 200 shown in FIG. 2. The classification scheme 61 is related to an XYZ report, and displayed based on classification scheme information (classification scheme folder) 62 stored in the classification-scheme storage unit 113. Assume further that the classification scheme 61 includes a classification folder (classification item) related to corporation B, and this folder is selected. In this case, the search-result/classification-result display area 202 shown in FIG. 2 displays classification results belonging to the classification folder related to corporation B, and included in the results of classification performed on the currently selected database 111-i (DBi) using the classification scheme 61.

In this state, assume that search conditions for a narrow-down search are sequentially input to the search input area 201 shown in FIG. 2 by a user operation. Specifically, assume that search conditions are sequentially input, which are used for retrieving reports related to “business tie-up” from the reports related to corporation B and already classified using the classification scheme 61, and then narrowing a search from the retrieved reports to reports related to “Technical strategy”. The search conditions input to the search input area 201 are reported from the request input module 131 to the search module 121. The search module 121, in turn, executes a search for the data belonging to the currently selected classification folder that is related to corporation B and included in the classification scheme 61 (i.e., the reports related to corporation B and included in the database 111-i). Specifically, the search module 121 performs a search on the reports related to corporation B, using the term “Business tie-up”, and further performs a narrow-down search on the search results, using the term “Technical strategy”, as is indicated by arrow 63 in FIG. 6. The data-providing module 132 displays the search results of the search module 121 on search-result/classification-result display area 202 shown in FIG. 2. If the results of classification, performed on the database 111-i (DBi) using the classification scheme 61, are not stored in the classification-scheme storage unit 113, the data of DBi is automatically classified based on the classification scheme 61.

After performing a search using the search conditions input to the search input area 201, the search module 121 stores, into the search-condition storage unit 112, the search conditions as a log in a folder format, with the search conditions linked to the currently selected classification folder of the classification scheme. If a narrow-down search is performed using a plurality of sequentially input search conditions, as described above, the search conditions are grouped together as a search condition log having a hierarchical structure. The search condition log is stored as a search-condition-log folder into the search-condition storage unit 112. In the above-described example in which a narrow-down search is performed using the terms “Business tie-up” and “Technical strategy”, a search-condition-log folder 65 is stored into the search-condition storage unit 112 as indicated by arrow 64 in FIG. 6. The search-condition-log folder 65 has a hierarchical structure in which data related to “Business tie-up” is regarded as upper class data, and data related to “Technical strategy” is regarded as lower class data. Further, the search-condition-log folder 65 is regarded as a lower-class classification folder related to corporation B and included in the classification scheme information 62, and is linked to the classification folders related to corporation B. The classification scheme information 62 is stored in the classification-scheme storage unit 113. Note that the search-condition-log folder 65 may be automatically stored into the search-condition storage unit 112, or be stored in accordance with a user instruction. Further, search-condition-log folders stored in the search-condition storage unit 112 may be managed in units of users.

Assume here that a classification icon corresponding to the classification scheme information 62 stored in the classification-scheme storage unit 113 is selected from the classification icon list displayed on the classification-icon-list display area 204 shown in FIG. 2. Assume further that the classification scheme information 62 in the classification-scheme storage unit 113 is linked to the search-condition-log folder 65 in the search-condition storage unit 112 as shown in FIG. 6. When the classification scheme information 62 (to-be-displayed classification scheme 61) specified by the selected classification icon is linked to the search-condition-log folder 65 (step S21), the data-providing module 132 does not display, as the classification scheme 61, only the classification scheme indicated by the search-condition-log folder 65, which differs from the case of FIG. 6. Specifically, as shown in FIG. 7, the data-providing module 132 displays the classification scheme 61 including the search-condition-log folder 65 (step S22). That is, the data-providing module 132 displays the search-condition-log folder 65 as part of the classification scheme 61. The search-condition-log folder 65 is positioned as a lower-class folder that is included in the classification scheme 61 and related to corporation B.

As described above, in the embodiment, search conditions used in a search (narrow-down search) already performed on an arbitrary classification folder of an arbitrary classification scheme are displayed in a folder format in a lower class of the classification folder. As a result, users can easily recognize, on the screen, on which classification folders and using which search conditions, searches were performed.

In the embodiment, users can drag & drop (D & D) the search-condition-log folder 65 in the classification scheme 61 into any other desired classification folder as indicated by arrow 71 of FIG. 7. Assume here that the request input module 131 detects that the search-condition-log folder 65 in the classification scheme 61 has been dragged and dropped into any other arbitrary classification folder (step S23). In this case, the request input module 131 instructs the search module 121 to perform a search (narrow-down search) using the search-condition-log folder 65 (step S24). Namely, the request input module 131 instructs the search module 121 to perform a search (narrow-down search) on the data belonging to the classification folder as a drag & drop destination, based on a search condition log included in the search-condition-log folder 65.

In response to the instruction from the request input module 131, the search module 121 performs a search on the data belonging to the classification folder selected by the user, based on the search condition log selected by the user (step S25). In the embodiment, a search is performed using term “Business tie-up”, and then a narrow-down search is performed using term “Technical strategy”. The data-providing module 132 displays the search results of the search module 121 on the search-result/classification-result display area 202 shown in FIG. 2 (step S26).

As described above, in the embodiment, the history of search conditions utilized in the past can be re-utilized simply by dragging and dropping, into a classification folder as a narrow-down search target, a search condition log folder displayed as part of a classification scheme. The search-condition-log folder 65 may be stored in the classification-scheme storage unit 113 as part of the classification scheme information 62, i.e., as a lower-class folder of the classification folder related to corporation B and included in the classification scheme information 62. Further, the search-condition-log folder 65 may be constructed such that its contents can be edited on the screen by a user operation. Furthermore, the contents of a plurality of search-condition-log folders may be collected into a new search-condition-log folder. These structures enable a search to be performed based on more appropriate search conditions.

[Modification]

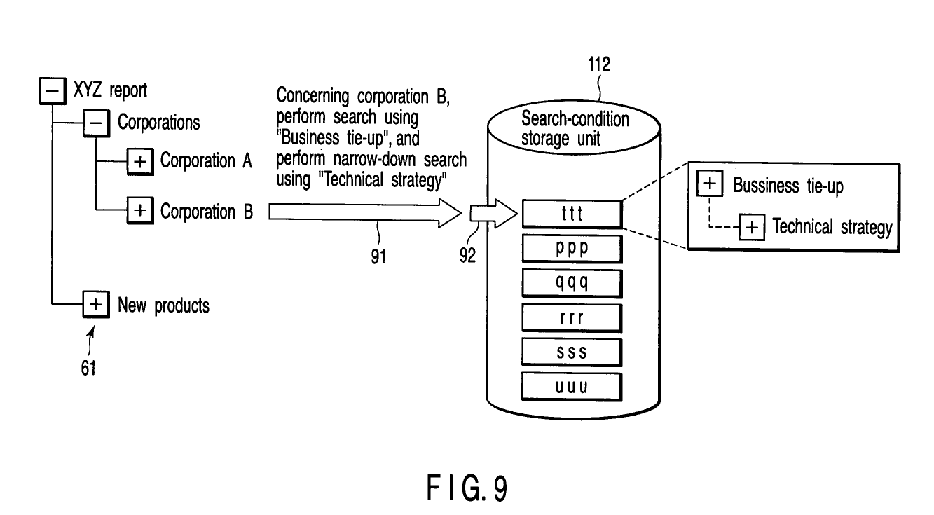

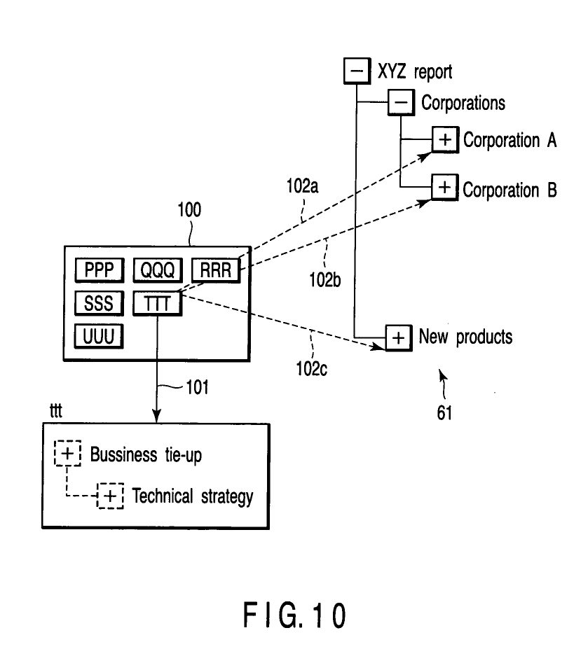

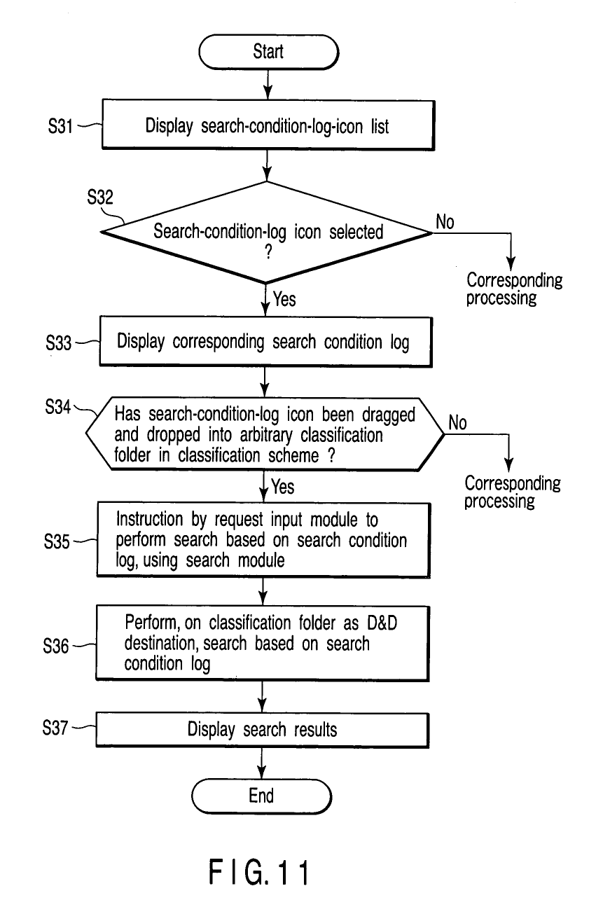

Referring now to FIGS. 9 to 11, a modification of the embodiment will be described. FIG. 9 is a view illustrating the flow of data during search in a modification of the embodiment. FIG. 10 is a view illustrating a display screen example, used during search, utilizing a search-condition-log-icon list. FIG. 11 is a flowchart illustrating the procedure of a search process utilizing the search-condition-log-icon list. This modification is characterized in that logs of search conditions are separated from classification schemes to which the search conditions are applied, and are displayed as a list of search condition logs in an icon format on the display screen 200.

Assume here that as indicated by arrow 91 in FIG. 9, the search module 121 has performed, using the term “Business tie-up”, a search on data (report concerning corporation B) belonging to a classification folder related to corporation B and included in the classification scheme 61, and then has performed a narrow-down search on the results of the above search using the term “Technical strategy”. After the narrow-down search, the search module 121 stores search-condition-log information “ttt” into the search-condition storage unit 112, as indicated by arrow 92 in FIG. 9. The search-condition-log information “ttt” corresponds to the search-condition-log folder 65, and has a hierarchical structure in which data related to “Business tie-up” is regarded as upper-class data, and data related to “Technical strategy” is regarded as lower-class data. Assume that “ttt” is assigned as an ID to the search-condition-log information “ttt”, and that the search-condition storage unit 112 already stores search-condition-log information items “ppp”, “qqq” , “rrr”, “sss” and “uuu” having IDs of “ppp” “qqq”, “rrr”, “sss” and “uuu”, respectively, as shown in FIG. 9.

In the modification, when a classification scheme is displayed on the classification-scheme display area 205, the data-providing module 132 can switch the classification-icon-list display area 204 of the display screen 200 to a search-condition-log-icon-list display area in accordance with a user operation. The search-condition-log-icon area is used to display the search-condition-log-icon list 100 shown in FIG. 10. When the classification-icon-list display area 204 is switched to the search-condition-log-icon-list display area, the data-providing module 132 generates a search-condition-log-icon list 100 corresponding to the search condition logs indicated by the IDs of the search-condition-log information stored in the search-condition storage unit 112. The data-providing module 132 displays the search-condition-log-icon list 100 on the search-condition-log-icon-list display area (step S31). Thus, in the modification, logs of search conditions used in searches in the past are displayed in a list using icons, which enables users to recognize the search condition logs on the screen.

In the example of FIG. 10, a list of search-condition-log icons “PPP”, “QQQ”, “RRR”, “SSS”, “TTT” and “UUU” corresponding to the IDs of the search-condition-log information items “ppp”, “qqq”, “rrr”, “sss”, “ttt” and “uuu” shown in FIG. 9 is displayed as the search-condition-log-icon list 100. When the classification-icon-list display area 204 is switched to the search-condition-log-icon-list display area, the data-providing module 132 allocates part of the display screen 200 as a search-condition-log display area for displaying search condition logs.

Assume here that when the search-condition-log-icon list 100 shown in FIG. 10 is displayed, an arbitrary search-condition-log icon has been selected therefrom (step S32). At this time, the data-providing module 132 displays, on the search-condition-log display area, the search condition log indicated by the search-condition-log information that is specified by the selected search-condition-log icon (step S33). As a result, users can recognize, on the screen, the search condition log corresponding to their selected search-condition-log icon. FIG. 10 shows the case where the search-condition-log icon TTT is selected, therefore the corresponding search condition log “ttt” is displayed as indicated by arrow 101.

In the modification, users can drag and drop a search-condition-log icon, selected from the search-condition-log-icon list 100, into a desired classification folder in a classification scheme displayed on the classification-scheme display area 205. Assume here that the classification scheme 61 shown in FIG. 10 is displayed on the classification-scheme display area 205, and that an operation is performed for dragging and dropping, into an arbitrary classification folder in the classification scheme 61, the search-condition-log icon TTT selected from the search-condition-log-icon list 100, as is indicated by arrow 102a, 102b or 102c in FIG. 10.

In this case, the request input module 131 detects that the search-condition-log icon “TTT” is dragged and dropped into the arbitrary classification folder in the classification scheme 61 (step S34). Then, the request input module 131 instructs the search module 121 to perform a search (narrow-down search) based on the search condition log “ttt” indicated by the search-condition-log icon “TTT” (step S35). Namely, the request input module 131 instructs the search module 121 to perform a narrow-down search, based on the search condition log “ttt”, on the data belonging to the classification folder as a drag & drop destination.

In response to the instruction from the request input module 131, the search module 121 performs, in the same manner as at step S25, a narrow-down search on the data belonging to the classification folder selected by the user, based on the search condition log “ttt” selected by the user (step S36). As previously mentioned, the search condition log “ttt” has a hierarchical structure in which data related to “Business tie-up” is regarded as upper-class data, and data related to “Technical strategy” is regarded as lower-class data. Accordingly, at step S36, a search is performed using term “Business tie-up”, and then a narrow-down search is performed using term “Technical strategy”. The data-providing module 132 displays the search results of the search module 121 on the search-result/classification-result display area 202 shown in FIG. 2 (step S37).

As described above, in the modification, the user can re-utilize the history of search conditions utilized in the past, simply by dragging and dropping a desired search-condition-log icon, included in the search-condition-log-icon list 100, into a classification folder as a narrow-down search target. The search condition log indicated by search-condition-log information may be constructed to be able to be edited on the screen by a user operation. Further, the contents of a plurality of search-condition-log information items may be collected into new search-condition-log information, thereby generating a new search-condition-log icon corresponding thereto.

Additional advantages and modifications will readily occur to those skilled in the art. Therefore, the invention in its broader aspects is not limited to the specific details and representative embodiments shown and described herein. Accordingly, various modifications may be made without departing from the spirit or scope of the general inventive concept as defined by the appended claims and their equivalents.

1. A data search system comprising:
a search module configured to search, for data, an arbitrary database selected from a group of databases, using a search condition designated by a user, the search module being able to utilize, for a search of the data, a classification scheme of data of the selected database;
a user interface configured to enable the user to select an arbitrary classification scheme from a group of classification schemes indicated by classification scheme information, the user interface being also configured to enable the user to select, from the group of databases, a database to which the selected classification scheme is applied, the classification scheme information being stored in a classification-scheme storage unit as results of classification performed on data of arbitrary databases; and
a classification module configured to classify the data of the selected database based on the selected classification scheme.

2. The data search system according to claim 1, wherein the user interface includes:
a data-providing module configured to display, in a list form on a display unit, classification icons indicating the group of classification schemes, and the group of databases; and
a request input module configured to instruct the classification module to apply, to an arbitrary database included in the group of databases, a classification scheme included in the group of classification schemes, when an arbitrary classification icon is selected from the classification icons and the selected classification icon is dragged and dropped to the arbitrary database, the classification scheme being specified by the selected classification icon.

3. The data search system according to claim 2, wherein the data-providing module displays, on the display unit, the classification scheme specified by the selected classification icon.

4. The data search system according to claim 2, further comprising:
an input unit used by the user for input operations including selection of the arbitrary database from the group of databases, designation of the search condition, selection of the arbitrary classification scheme from the group of classification schemes, and a drag and drop operation; and
the display unit.

5. The data search system according to claim 4, further comprising:
the group of databases; and
the classification-scheme storage unit.

6. The data search system according to claim 1, wherein:
the classification scheme information is stored as classification scheme files in the classification-scheme storage unit; and
the user interface includes:
a data-providing module configured to display, in a list form on a display unit, the classification scheme files and the group of databases; and
a request input module configured to instruct the classification module to apply, to an arbitrary database, an arbitrary classification scheme included in the group of classification schemes and indicated by an arbitrary classification scheme file, when the arbitrary classification scheme file is selected from the classification scheme files, and the arbitrary database is selected from the group of databases.

7. The data search system according to claim 1, wherein:
the classification scheme information stored in the classification-scheme storage unit has a hierarchical structure including a group of classification folders;
the user interface includes a data-providing module configured to display, on a display unit, an arbitrary classification scheme included in the group of classification schemes and selected in accordance with a user operation;
the search module is used to search data belonging to an arbitrary classification folder in a classification scheme included in the group of classification schemes and displayed by the data-providing module, and to store, linked to the classification folder into one of a search-condition storage unit and the classification-scheme storage unit, a search-condition-log folder including a log of a search condition used for the search, when the user selects the classification folder and instructs the search module to search the data, the search-condition storage unit being used to store a search condition designated by the user;
the data-providing module displays a search-condition-log folder as part of the selected classification scheme, when the search-condition-log folder exists, linked to a classification folder in the selected classification scheme, the classification folder being selected in accordance with a user operation.

8. The data search system according to claim 7, wherein:
the user interface includes a request input module configured to instruct the search module to perform a search based on the search-condition-log folder, when the data-providing module displays the classification scheme including the search-condition-log folder, and the search-condition-log folder is dragged and dropped into an arbitrary classification folder in the classification scheme including the search-condition-log folder; and
the search module performs, upon receiving the instruction from the request input module, a search on data belonging to the arbitrary classification folder into which the search-condition-log folder is dragged and dropped, the search being performed based on a search condition indicated by a search condition log in the search-condition-log folder.

9. The data search system according to claim 7, wherein:
the search module links the search condition log as the search-condition-log folder to the selected classification folder, the search-condition-log folder being regarded as a lower class folder included in the selected classification folder; and
the data-providing module displays the search-condition-log folder as the lower class folder of the selected classification folder linked to the search-condition-log folder.

10. The data search system according to claim 7, wherein:
the search-condition-log folder has a hierarchical structure representing respective classes of a plurality of search conditions, when the search-condition-log folder includes the plurality of search conditions used for a narrow-down search;
the data-providing module hierarchically displays the plurality of search conditions based on the search-condition-log folder when the search-condition-log folder includes the plurality of search conditions.

11. The data search system according to claim 1, wherein:
the classification scheme information stored in the classification-scheme storage unit has a hierarchical structure including a group of classification folders;
the user interface includes a data-providing module configured to display, on a display unit, an arbitrary classification scheme included in the group of classification schemes and selected in accordance with a user operation;
the search module searches data belonging to an arbitrary classification folder in a classification scheme included in the group of classification schemes and displayed by the data-providing module, and stores, as a search-condition-log information item into a search-condition storage unit, a log of a search condition used for the search, when the user selects the classification folder and instructs the search module to search the data;
the data-providing module displays, on the display unit, a search-condition-log-icon list representing logs of search conditions corresponding to search-condition-log information items stored in the search-condition storage unit, based on the search-condition-log information items, the search-condition-log information items including the search-condition-log information item;
the user interface includes a request input module configured to instruct the search module to perform a search based on a search-condition-log information item included in the search-condition-log information items and specified by a search-condition-log icon selected from the search-condition-log-icon list, when the search-condition-log icon is dragged and dropped into an arbitrary classification folder in the classification scheme; and
the search module performs, upon receiving the instruction from the request input module, a search on data belonging to the arbitrary classification folder into which the search-condition-log icon is dragged and dropped, the search being performed based on a search condition log indicated by the search-condition-log information item specified by the search-condition-log icon.

12. The data search system according to claim 11, wherein the data-providing module displays, on the display unit, a log of a search condition specified by an arbitrary search-condition-log icon, when the arbitrary search-condition-log icon is selected from the search-condition-log-icon list.

13. The data search system according to claim 1, further comprising an input unit used by the user for input operations including selection of the arbitrary database from the group of databases, designation of the search condition, and selection of the classification scheme from the group of classification schemes.

14. The data search system according to claim 13, further comprising:
the group of databases; and
the classification-scheme storage unit.

15. A classification method of classifying, in accordance with a request from a user, data of an arbitrary database selected from a group of databases, the method being employed in a data search system capable of utilizing, for a search of data, a classification scheme of data of the arbitrary database, the method comprising:
causing the user to select an arbitrary classification scheme from a group of classification schemes indicated by classification scheme information, the classification scheme information being stored in a classification-scheme storage unit as results of classification performed on data of arbitrary databases;
causing the user to select, from the group of databases, a database to which the selected classification scheme is applied; and
classifying the data of the selected database based on the selected classification scheme.

16. A computer program product for classifying, in accordance with a request from a user, data of an arbitrary database selected from a group of databases, the computer program product being employed in a data search system capable of utilizing, for a search of data, a classification scheme of data of the arbitrary database, the computer program product comprising:
computer-readable program code means for causing the user to select an arbitrary classification scheme from a group of classification schemes indicated by classification scheme information, the classification scheme information being stored in a classification-scheme storage unit as results of classification performed on data of arbitrary databases;
computer-readable program code means for causing the user to select, from the group of databases, a database to which the selected classification scheme is applied; and
computer-readable program code means for classifying the data of the selected database based on the selected classification scheme.
